(19) United States
(12) Patent Application Publication
(10) Pub. No.: US 2013/0207758 A1
(43) Pub. Date: Aug. 15, 2013

(54) SELECTABLE AND CONTROLLABLE DETENT USING SPATIALLY MODULATED MAGNETIC FIELDS

(71) Applicants: Alan L. BROWNE, Grosse Pointe, MI (US); Nancy L. Johnson, Northville, MI (US); Roy J. Mathieu, Rochester Hills, MI (US); Thomas A. Perry, Bruce Township, MI (US)

(72) Inventors: Alan L. BROWNE, Grosse Pointe, MI (US); Nancy L. Johnson, Northville, MI (US); Roy J. Mathieu, Rochester Hills, MI (US); Thomas A. Perry, Bruce Township, MI (US)

(73) Assignee: GM GLOBAL TECHNOLOGY OPERATIONS LLC, Detroit, MI (US)

(21) Appl. No.: 13/370,808

(22) Filed: Feb. 10, 2012

(51) Int. Cl. H01F 7/121; H01F 7/02

(52) U.S. Cl. 335/289; 335/285

(57) ABSTRACT

A detent device or mechanism may include a strut comprising at least one strut magnetic array, at least one detent magnetic array, and other components and systems. The at least one detent magnetic array and the at least one strut magnetic array may, for example, apply a magnetic detent force to the strut.

### FIELD OF THE PRESENT INVENTION

The present invention is related to mechanical detents including magnetic elements and other components.

### BACKGROUND

Many devices include detents and/or detent mechanisms. Detents may, for example, mechanically resist or arrest the movement of a component, strut, sliding mechanism, or other device; the rotation of a wheel, axle, spindle, or other device; or translation of a part, component, or device. Detents may typically arrest or resist movement in a direction using a spring-loaded ball bearing device, notched wheels, spring steel that snaps into position on flat surfaces or shallow notches in a shaft, and other mechanisms. A detent mechanism may divide rotation of a wheel, axle, spindle, or other device into discrete increments. Detents may be used in door hinges (e.g., vehicle door hinges), panel supports (e.g., a trunk support), knobs (e.g., radio control knobs), ratchet devices, rotary switches, scroll wheels (e.g., on a computer mouse or other device), sliding drawers, and/or other devices.

The function of detent mechanism or devices may be affected by different operating conditions. Detent mechanism operation may, for example, vary based on a spatially varying load (e.g., a gravity load) applied to a mechanism. For example, a vehicle door detent may require more force to overcome a detent resistance load when a vehicle is parked on a flat surface than when parked on a slope. The varying forces required to overcome a detent load may, for example, result in unpredictable detent behavior. A selectable or controllable detent may, therefore, be needed.

### SUMMARY

A detent device or mechanism may include a strut comprising at least one strut magnetic array, at least one detent magnetic array, and other components and systems. The at least one detent magnetic array and the at least one strut magnetic array may, for example, apply a magnetic detent force to the strut.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram of a magnetic array used in a detent device according to embodiments of the present invention;

FIG. 2 is a diagram of a detent device according to embodiments of the present invention;

FIG. 3 is a diagram of a detent device according to embodiments of the present invention;

FIG. 4 is a perspective view of a detent device according to embodiments of the present invention; and

FIG. 5 is a perspective view of a detent device according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. It will however be understood by those skilled in the art that the present invention may be practiced without these specific details. In other instances, well-known methods, procedures, and components have not been described in detail so as not to obscure the present invention.

A detent device according to embodiments of the present invention may apply a force or load (e.g., detent force, detent load, or other load) based on sensor feedback, detent device orientation, or other parameters. A detent device may, for example, apply a magnetic force (e.g., magnetic attraction and/or repulsion force) between two components of a detent device. Magnetic forces may resist motion or translation of a component of the detent device (e.g., a strut). Magnetic force may, for example, be overcome by applying a force to a strut or other component of the detent device, which exceeds a threshold magnetic force. Threshold magnetic force may, for example, be related to the magnitudes of magnetic poles associated with each detent component, a distance between components, and other parameters.

Magnetic forces may, for example, be applied using spatially modulated magnetic field based devices, electromagnets, permanent magnets, ferromagnetic metals, or other components or devices. Spatially modulated magnetic fields may, for example, include an array of magnetic field sources or magnetized regions in a material (e.g., a ferromagnetic metal). A magnet may, for example, be a material or object that is the source of a magnetic field, which is a vector field including a direction and a magnitude (e.g., an intensity or strength). A material (e.g., a ferromagnetic material, metal, or other type of material), object, or regions of a material or object may, for example, be positively or negatively charged. Spatially modulated magnet fields may, for example, include a unique combination or array of positively and negatively magnetized regions in a material. Each of multiple magnetized regions (e.g., magnetic regions, maxels, or other regions) may, for example, be a polarized magnetic field source of a pre-determined intensity. A magnetic region may be a region of varying size, surface area (e.g., 1 millimeter (mm) or greater in diameter), surface shape, or volume. Multiple positive or negative magnetically charged regions may be arranged in an array or pattern on a material. An array or pattern of magnetized regions may, for example, create a unique magnetic pattern, fingerprint or signature. The array of magnetized regions may, for example, be pre-selected, programmed, or determined to have desirable properties (e.g., with other materials or objects with an array of magnetic regions or other magnetic materials).

Arrays or patterns of magnetized regions on two or more materials or objects may be defined or pre-determined such that the two materials may complement one another. Arrays of magnetized regions (e.g., produced by poles or dipoles) on two materials may, for example, complement one another by causing the materials to be magnetically attractive, repulsive, or neutral. Attraction and/or repulsion or lack thereof between two arrays of magnetized regions may, for example, be a function of a distance between two materials. Two or more objects having complementing or matching (in an opposite manner) patterns of magnetized regions may be oriented or moved with respect to each other, or may have forces applied to each other, caused by the magnetized patterns. The patterns may match each other in a key-like fashion, where for each object, the pattern is, for example, equal and opposite to the other pattern.

In some embodiments, a magnitude of magnetic force between surfaces or objects including complimentary magnetic arrays may be greater than between typical magnetic surfaces or objects. A magnetic array may, for example, generate higher near-field magnetic flux than a typical magnet due to the fact that positively magnetized regions (e.g., positive poles) are located next to or in close proximity to negatively magnetized regions (e.g., negative poles). The close proximity of positively charged regions and negatively charged regions may result in reduced far-field magnetic flux and increase near-field magnetic flux because a shortest path or path of least resistance between oppositely polarized magnetized poles may be reduced. As a result of greater near field magnetic flux, magnetic force (e.g., attractive or repulsive magnetic force) between two complementary magnetic arrays may be increased.

In some embodiments, a detent device may include a strut (e.g., a component of a swing panel, gearshift, or any other device), which may include at least one strut magnetic array, at least one detent magnet including at least one detent magnetic array, and other components. At least one detent magnetic array and the at least one strut magnetic array may, for example, be operable to apply a magnetic detent force or load to the strut. A detent force may be applied to a strut by positioning a detent magnet array with respect to a strut magnetic array such that a magnetic attractive force between strut magnetic array and detent magnetic array is generated. An electromechanical system including an actuation device (e.g., a motor, actuator, or other device) may for example control a distance between a strut magnetic array and detent magnetic array. An electromechanical system may, for example, control a distance between a strut magnetic array and detent magnetic array based on sensor (e.g., a proximity sensor, electromagnetic sensor, ultrasonic sensor, a camera, a gyroscopic sensor, or other type of sensor) measurements. A sensor may, for example, measure a distance between a vehicle door, swing panel, or other components associated with a detent device and surrounding objects. A sensor may, for example, measure a spatial orientation of a detent device, a swing panel, a vehicle or other components.

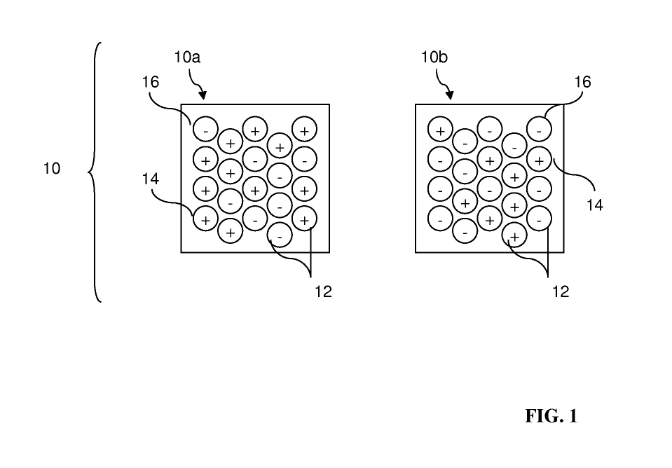

FIG. 1 is a perspective view of a detent device according to embodiments of the present invention. A detent device may include at least one magnetic component (e.g., a magnet material). A magnetic component may, for example, be an electromagnet, permanent magnet, ferromagnetic metal, magnetic material, a metal, or other components or devices. A magnet may, for example, be a material or object that generates or produces a magnetic field. A magnetic field is a vector field including a direction and a magnitude (e.g., an intensity or strength). Magnetic field vectors or field lines originate at a magnetic pole (e.g., magnetic dipoles). Regions of a material or object may be or may include magnetic dipoles. Magnetic dipoles may, for example, be magnetized regions (e.g., sources of magnetic fields) of varying magnitude.

In some embodiments, a magnetic material, component, or device may include or generate a spatially modulated magnetic field (e.g., a magnetic array). Spatially modulated magnetic fields may include patterns which may match, complement or fit to other spatially modulated magnetic fields. Spatially modulated magnetic fields may, for example, be generated by an array 10 of magnetic field sources or magnetized regions 12 in a material (e.g., a ferromagnetic material). A magnetic array 10 may, for example, include an arrangement and/or combination of one or more magnetized regions 12 (e.g., maxels, magnetized areas, magnetic dipole regions, or other regions). Magnetized regions 12 may include positively magnetized regions 14, negatively magnetized regions 16, or other types of magnetized regions. Each of multiple magnetized regions 12 may, for example, be a positively polarized magnetic field source 14 or negatively polarized magnetic field source 16 of pre-determined magnitude (e.g., magnitude, strength, or intensity of magnetic field). A magnetic region 12 may be a region of any size, surface area (e.g., 1 millimeter (mm) or greater in diameter), surface geometry, or volume. Multiple positively magnetized regions 14 and negative magnetized regions 16 may be arranged in an array or pattern on a material (e.g., generating a spatially modulated magnetic field). Positively magnetized regions 14 and negative magnetized regions 16 may, for example, be arranged in a grid, staggered grid, predetermined pattern (e.g., a spiral or other pattern), random pattern, or any other spatial arrangement. A magnetic array 10 may, for example, generate a unique magnetic field (e.g., a magnetic finger print or signature). In some embodiments, magnetic array 10 may include a single magnetized region.

Spatially modulated magnetic fields generated by magnetic arrays 10 on two or more materials or objects may be defined or pre-determined such that the two materials may complement one another. Spatially modulated magnetic fields generated by magnetic arrays 10 on two or more materials may, for example, complement one another by generating an attractive, repulsive, or neutral magnetic force between the two materials. The strength or magnitude of the magnetic force between two magnetic arrays 10 may be a function of a distance between two materials and/or other parameters.

Magnetic arrays 10 may, for example, be predefined such that two objects are attracted in a predefined orientation. Two materials (e.g., a first material and a second material) may be magnetically attracted in a predefined orientation if magnetic arrays 10 on each of the materials (e.g., magnetic array 10a on a first material and magnetic array 10b on a second material) are attracted. Magnetic arrays of two materials (e.g., magnetic array 10a and magnetic array 10b) may be attracted if positively magnetized regions 14 on first magnetic array 10a align with negatively charged regions 16 on second magnetic array 10b and negatively magnetized regions 16 on first magnetic array 10a align with positively charged regions 14 on second magnetic array 10b. The magnitude of attractive force between magnetic arrays 10 of two materials (e.g., a first magnetic array 10a and a second magnetic array 10b) may, for example, be related to or be a function of a distance between two materials and/or other parameters. A magnetic attraction force may, for example, occur if two magnetic arrays 10 are within a threshold distance of one another. Two magnetic arrays 10 may, for example, be magnetically neutral or magnetically repulsive beyond or outside of a threshold distance. Similarly, a magnetic repulsive or repelling force may, in some embodiments, occur if two magnetic arrays 10 (e.g., a first magnetic array 10a and a second magnetic array 10b) are within a threshold distance of one another.

In some embodiments, magnetic force between two objects and/or materials may be related to an orientation of a first magnetic array 10a of a first object relative to an orientation of a second magnetic array 10b of a second object. In some spatial orientations, an attractive magnetic force may be applied between two magnetic arrays and in other spatial orientations a repulsive magnetic force or neutral magnetic force (e.g., zero or minimal magnetic force) may be applied between the two magnetic arrays. For example, a first magnetic array 10a (e.g., magnetic array A) may be a grid of positively magnetized regions 14 and negatively magnetized regions 16 in a predetermined arrangement, layout, and/or pattern. A second magnetic array 10b (e.g., magnetic array A′) may be a grid of positively magnetized regions 14 and negatively magnetized regions 16 in a predetermined arrangement, layout, and/or pattern which is complimentary to the grid of a first magnetic array 10a. A grid of a first magnetic array 10a and of a second magnetic array 10b may, for example, be complimentary or match if in a certain orientation at least one or a substantial number of positive magnetic regions 14 and negative magnetic regions 16 in a first magnetic array 10a may be aligned with negative magnetic regions 16 and positive magnetic regions 14, respectfully, in a second magnetic array 10b.

In some embodiments, if an attractive magnet force is applied between two magnetic arrays 10 (e.g., a first magnetic array 10a and second magnetic array 10b), a force may applied to overcome the attractive magnetic force. Attractive magnetic force may, for example, be overcome by applying a force opposite to the direction of the magnetic attractive force between first magnetic array 10a and second magnetic array 10b. Attractive magnetic force may, for example, be overcome by applying a shear force or load to the connection between first magnetic array 10a and second magnetic array 10b. Attractive magnetic force may, in some embodiments, be overcome by applying other types of loads and/or using other methods.

Similarly, magnetic arrays of two materials (e.g., magnetic array 10a and magnetic array 10b) may be repelled if positively magnetized regions 14 on a first magnetic array 10a align with positively charged regions 14 in a second magnetic array 10b and negatively magnetized regions 16 in a first magnetic array 10a align with negatively charged regions 16 in a second magnetic array 10b.

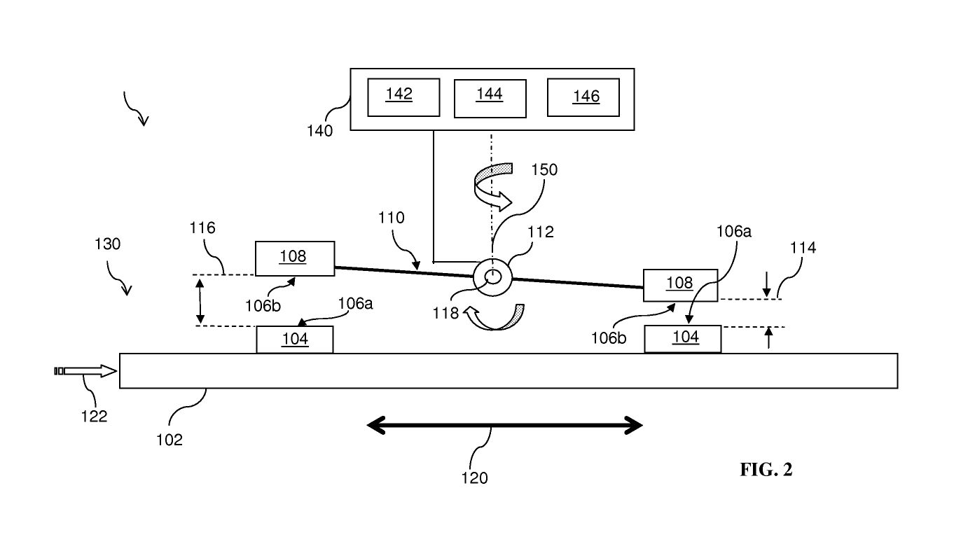

FIG. 2 is a schematic illustration of a detent device according to embodiments of the present invention. Detent device 100 may, for example, be a component of various systems or devices (e.g., a vehicle door, a swing panel device, a vehicle trunk device, a gearshift, or another type of device). A detent device 100 may include strut(s) 102, electromechanical system(s) 110, and possibly other components. A strut 102 may, for example, be a component, structural member, or other type of component of a wide variety of devices and/or systems. Strut 102 may, for example, be a component or components in any type of device, system, or assembly. A strut 102 may, for example, be a structural component designed to resist longitudinal compression. Struts 102 may provide support in their lengthwise direction. A strut 102 may be used to separate two components, provide support to components, or for other purposes. Strut 102 may, for example, be fabricated from metal, plastics, composite materials, wood, or another type of material.

A strut 102 may, for example, include strut magnetic components 104. Strut magnetic components 104 may, for example, include a magnetic array 106a (e.g., magnetic array 10a, magnetic array 10b). In some embodiments, a strut 102 may include a magnetic array 106a (e.g., a portion of strut 102 may include or may be a magnetic array 106a). A magnetic array 106a (e.g., included in or associated with a strut 102) may, for example, include magnetized regions 12 (e.g., magnetic field sources) arranged in an array 10 (e.g., a strut magnetic array pattern).

Strut 102 may be a component of a device and may move or translate in one or more directions 120. Strut 102 may translate in reaction to a force applied by a user, another device, or system. Translation or movement 120 of strut 102 may, for example, be limited or impeded creating a detent (e.g., detent action). A force, moment, or load limiting or impeding translation or movement of strut 102 may be a detent force or resistance. A detent force or resistance may be felt by a user interacting with a detent device 100. A detent force or resistance may, for example, cause a user to feel a click, bump, slight resistance, impediment, or other feedback.

In some embodiments, a detent force may result from a magnetic force (e.g., an attractive magnetic force) applied between a strut magnet 104 and a detent magnet 108. A magnetic force (e.g., detent force) may be generated between strut magnet 104 and detent magnet 108 if strut magnet 104 and detent magnet 108 are within a predefined distance. A detent force may impede motion of strut 102, and a detent force may be overcome by a force applied to strut 102. A detent force may, for example, be related to or be proportional to the strength of a magnetic force between strut magnet 104 and detent magnet 108.

In some embodiments, a detent force may result from a magnetic force (e.g., an attractive force) between magnetic array 106a (e.g., strut magnetic array 106a) associated with strut 102 and magnetic array 106b (e.g., detent magnetic array 106b) associated with detent magnet 108. Translation 120 of strut 102 may, for example, be impeded or resisted by a detent force associated with or resulting from a magnetic attraction force applied between strut magnetic array 106a (e.g., magnetic array 10a) and detent magnetic array 106b associated with an electromechanical system magnet or detent magnet 108 (e.g., magnetic array 10b). Translation 120 of strut 102 may, for example, be impeded by reducing or stopping movement of strut 102. If detent magnet 108 (e.g., detent magnetic array 106b) is within a predefined distance 114 of strut magnetic array 106a, a magnetic force may be applied between detent magnetic array 106b and strut magnetic array 106a. A magnetic force applied between detent magnetic array 106b and strut magnetic array 106a may, for example, impede the motion of strut 102. The magnetic force impeding the motion of strut 104 may, for example, be overcome by applying a predetermined force or load to strut 104. In some embodiments, a shear load may be applied to a joint between strut magnetic array 106a and detent magnetic array 106b. A load greater than a predefined threshold applied to strut 104 may, for example, overcome magnetic force between magnetic array 106a and detent magnetic array 106b (e.g., detent magnet 108). The magnetic force between strut magnetic array 106a and detent magnetic array 106b may be overcome causing strut magnetic array 106a to shear away from detent magnetic array 106b and/or detent magnet 108.

In some embodiments, strut magnetic array 106a and detent magnetic array 106b may be complementary magnetic arrays. Strut magnetic array 106a and detent magnetic array 106b may each include an arrangement of magnetized regions organized such that a predefined magnetic force is generated if strut magnetic array 106a and detent magnetic array 106b are within a predefined distance of one another. Strut magnetic array 106a and detent magnetic array 106b may each include an arrangement of magnetized regions organized such that a predefined magnetic force is generated if strut magnetic array 106a and detent magnetic array 106b are in predefined orientations with respect to one other (e.g., faces or surfaces of detent magnet 108 and strut magnet 108 are aligned). Use of complementary magnetic arrays (e.g., strut magnetic array 106a and detent magnetic array 106b) rather than typical magnets (e.g., electromagnetic magnets, permanent magnets, etc.) may allow a user or designer enhanced control of detent force strength (e.g., generating greater magnetic forces than typical magnets).

A detent device 100 may include an electromechanical system 110. Electromechanical system 110 may, for example, include at least one magnet 108, at least one actuation device 112, a pivot arm 120, and/or other components. Electromechanical system 110 may control the location of magnets 108 relative to spatially modulated magnetic field arrays 106 associated with strut 102 (e.g., magnetic components 104). Electromechanical system 110 may, for example, control a distance 116 between a magnet 108 and magnetic array 106 associated with strut 102 using an actuation device 112. Actuation device 112 may, for example, be a motor (e.g., an alternating current (AC) motor, direct current (DC) motor), actuator, or other actuation device. In some embodiments, actuation device 112 may rotate or translate electromechanical system 110 about a pivot point 118.

In some embodiments, actuation device 112 may control a location of one or more detent magnets 108 relative to strut magnets 104 based on input from a control system 140. In some embodiments, actuation device may control a location of a single detent magnet 108 relative to strut magnets 104, or in some embodiments multiple detent magnets 108 relative to strut magnets 104. Control system 140 may, for example, control and/or provide input to actuation device 112 based on information measured by a sensor 142. Examples of sensor 142 include, but are not limited to: a proximity sensor (e.g., associated with a car door, trunk, swing panel, or other component); a magnetic, electrostatic, or electromagnetic sensor; a sonar sensor, (e.g., an ultrasonic sensor); an optical rangefinder (e.g., parallax, laser); a camera; a gyroscopic sensor; an orientation sensor; an accelerometer, an inertial measurement unit (IMU); a radar system or unit (e.g., near-field, far-field, vehicle-to-vehicle, and vehicle-to-infrastructure); GPS, map information-based system related to features proximate to a vehicle's location; a downlink information system (e.g., OnStar); or other type of sensor. Sensor 142 may, for example, measure a distance between a swing panel, vehicle door, or other component associated with detent device 100 and any surrounding objects. Sensor 142 may, in some embodiments, measure or determine a spatial orientation of a component associated with strut 102 and/or detent device 100 (e.g., a swing panel, vehicle door, or other component). For example, sensor 142 may measure the angle of a vehicle, vehicle door (e.g., sensor may determine a slope of a hill vehicle is parked on), or other component. Control system 140 may, for example, include one or more processor(s) or controller(s) 144, memory 146, and potentially other components. Processor or controller 144 may be, for example, a central processing unit (CPU), a chip, or any suitable computing or computational device. Processor or controller 144 may include multiple processors, and may include general-purpose processors and/or dedicated processors such as graphics processing chips. Processor 144 may execute code or instructions, for example, stored in memory 146 or another device.

In some embodiments, actuation device 112 may control a location of one or more magnets 108 relative to magnetic arrays 106 associated with strut 102 by rotating or pivoting at least one magnet 108 about a pivot point 118 and/or axis 150. At least one magnet 108 may, for example, be associated with (e.g., attached to, fastened to, or otherwise associated with) a pivot arm 120. Actuation device 112 may control a distance 116 between a magnet 108 and magnetic array 106 associated with a strut 102 by rotating magnet 108 about pivot point 118. Actuation device 112 may, for example, control a distance between a detent magnet 108 and magnetic array 106 by rotating one or more magnets 108 about one or more axes of rotation 150. Axes of rotation 150 may, for example, be perpendicular to a surface of detent magnet 108 or magnetic array 106, may be parallel to surface of magnetic array 106, may be any defined by any other angle, or may be defined relative to any other surface or feature.

In some embodiments, a detent force may be generated by actuation device 112. Actuation device 112 may, for example, translate magnet 108 to a location within a predefined distance 114 of a magnetic array 106 associated with strut 102 such that a magnetic attract force is applied between magnetic array 106 and magnet 108. The magnetic force applied between magnetic array 106 and magnet 108 may impede movement or translation of strut 102.

In some embodiments, actuation device 112 may control a location of at least one magnet 108 relative to at least one strut magnet 104 (e.g., magnetic array 106a) by directly applying a force to magnet 108. Actuation device 112 may, for example, push magnet 108 towards or pull magnet 108 away from magnetic array 106. If magnet 108 and magnetic array 106 associated with a strut 102 are with a predefined distance 114, an attractive magnetic force may be applied between magnet 108 and magnetic array 106 impeding the motion of strut 102 resulting in a detent.

In some embodiments, detent device 100 may be associated with a magnetorheological (MR) fluid 130. An MR fluid 130 may, for example, include a fluid (e.g., oil, mineral oil, synthetic oil, water, glycol, or other fluid), magnetic materials (e.g., iron particles, ferromagnetic materials, or other type of materials) suspended in the fluid, and/or other components. Magnetic materials may, for example, be high aspect ratio ferrous metals or other types of materials. Magnetic materials suspended in fluid may align along lines of magnetic flux applied to MR fluid 130. Magnetorheological (MR) fluid 130 may have two or more states. In a first state, no magnetic flux may be applied to MR fluid 130 and MR fluid 130 may have reduced yield strength, reduced shear strength, and other material properties. In a second state, a magnetic flux may be applied to MR fluid 130, and MR fluid 130 shear strength, yield strength, and other material properties may be increased. A magnetic field or magnetic flux may, in some embodiments, be applied to MR fluid 130 in a direction perpendicular to fluid flow or in another direction. By applying a magnetic flux perpendicular to a direction of fluid flow, magnet particles may be aligned to form a structure, which increases shear strength in a direction perpendicular to the magnetic flux.

According to some embodiments, detent device 100 may be associated with or immersed in MR fluid 130. Magnetorheological fluid 130 may, for example, resist translation 120 of strut 102. For example, if a magnetic field (e.g., magnetic flux) is applied perpendicular to a direction of strut 102 translation, MR fluid 130 may resist translation of strut 102. MR fluid 130 may, for example, increase a detent force applied to strut 102. A magnetic attractive force (e.g., a magnetic flux) between magnetic array 106a associated with strut 102 and magnetic array 106b associated with detent magnet 108 may, for example, be applied to MR fluid 130 increasing a magnetic detent force (e.g., applied to resist translation or movement of strut 102).

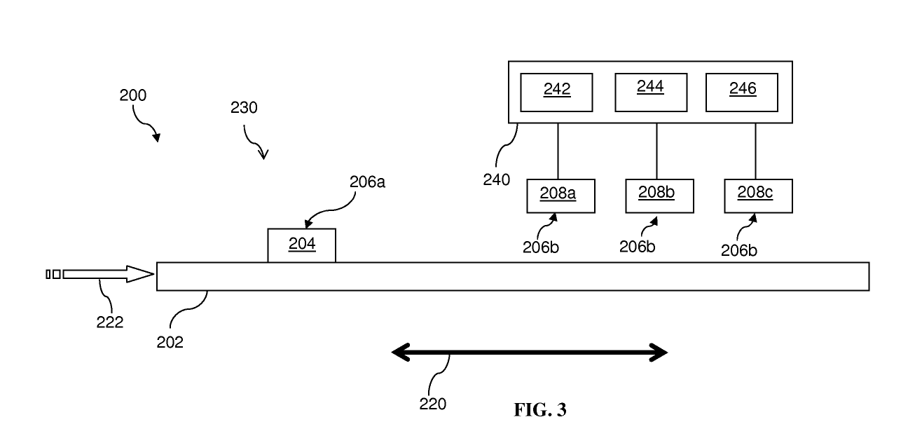

FIG. 3 is a schematic diagram of a detent device according to embodiments of the present invention. Detent device 200 may, for example, be a component of various systems or devices (e.g., a vehicle door, a swing panel device, a vehicle trunk device, a gearshift, or another type of device). Detent device 200 may, for example, include a strut 202, one or more detent magnets 208a, 208b, 208c, and other components. Strut 202 may, for example, include strut magnetic components 204. Strut magnetic components 204 may, for example, include a magnetic array 206a (e.g., magnetic array 10a). In some embodiments, a strut 202 may include a magnetic array 206a (e.g., a portion of strut 202 may include or may be a magnetic array 206). A magnetic array 206a (e.g., included in or associated with a strut 202) may, for example, include magnetized regions 12 (e.g., magnetic field sources) arranged in an array 10 (e.g., a strut magnetic array pattern).

In some embodiments, one or more detent magnets 208a, 208b, 208c may be electromagnets (e.g., solenoids, torroids, or other electromagnetic devices), permanent magnets, ferromagnetic materials, or other type of magnets. Detent magnets 208a, 208b, 208c may include magnetic arrays 206b. Detent magnets 208a, 208b, 208c may, in some embodiments, be activated or deactivated by, or generate a magnetic field from, one or more detent magnets 208a, 208b, 208c. Magnetic arrays 206b associated with detent magnets 208a, 208b, 208c may, for example, be complementary to magnetic arrays 206a associated with strut 202.

In some embodiments, a control system 240 may activate or deactivate detent magnets 208a, 208b, 208c based on sensor 142 input or other parameters. Sensor 242 may, for example, be a proximity sensor (e.g., associated with a car door, trunk, swing panel, or other component), electromagnetic sensor, ultrasonic sensor, a camera, a gyroscopic sensor, inertial measurement unit(s) (IMU), or other type of sensor. Control system 240 may, for example, include one or more processor(s) or controller(s) 244, memory 246, and potentially other components. Processor or controller 244 may be, for example, a central processing unit (CPU), a chip, or any suitable computing or computational device. Processor or controller 244 may include multiple processors, and may include general-purpose processors and/or dedicated processors such as graphics processing chips. Processor 244 may execute code or instructions, for example, stored in memory 246 or another device

Strut 202 may be a component of a device or system and may move or translate in one or more directions 220. Strut 202 may translate in reaction to a force applied by a user, device, or system. Translation or movement 220 of strut 202 may, for example, be limited or impeded creating a detent (e.g., detent action). A detent may be felt by a user interacting with detent device 100. Translation 120 of strut 102 may be impeded if a magnetic attraction force is applied between magnetic region 206a (e.g., magnetic array 10a) associated with strut 202 and magnetic region 206b associated with a detent magnet 208a, 208b, 208c. Translation 220 of strut 202 may, for example, be impeded by reducing or stopping movement of strut 202. If a detent magnet 208a, 208b, 208c is within a predefined distance of magnetic array 206a, a magnetic detent force (e.g., attractive magnetic force, repulsive magnet force, or other magnetic force) may be applied between strut magnet 204 (e.g., magnetic array 206a) and detent magnet 208a, 208b, 208c (e.g., detent magnetic array 106b). A magnetic detent force applied between detent magnet 208a, 208b, 208c and spatially modulated magnetic field array 206a may, for example, impede the motion of strut 202. The magnetic detent force impeding the motion of strut 202 may, for example, be overcome by applying a predetermined force or load to strut 202. A load greater than a predefined threshold applied to strut 202 may, for example, overcome magnetic force between magnetic array 206a and detent magnet 208a, 208b, 208c. The magnetic force between spatially modulated array 206a and detent magnet 208a, 208b, 208c may be overcome causing magnetic array 206a to shear away from magnet 208a, 208b, 208c.

In some embodiments, detent magnets 208a, 208b, 208c may be electromagnets and may be activated or deactivated by control system 240. Control system 240 may, for example, activate or deactivate detent magnets 208a, 208b, 208c based on sensor 242 input. For example, detent device 200 may be associated with or be a component of a swing panel (e.g., a vehicle door, trunk lid, or other component). Sensor 242 may, for example, measure a distance between the swing panel and other objects. If sensor 242 measured distance between the swing panel and an object is within a predefined threshold, control system 240 may activate one or more detent magnet 208a, 208b, 208c and impede and/or movement or translation of a vehicle door. Collision of the swing panel (e.g., vehicle door with surrounding objects may, therefore, be mitigated or prevented.

According to some embodiments, detent device 200 may be associated with or immersed in MR fluid 230. MR fluid 230 may, for example, resist translation 220 of strut 202. For example, if a magnetic field (e.g., magnetic flux) is applied perpendicular to a direction of strut 202 translation, MR fluid 230 may resist translation of strut 202. MR fluid 230 may, for example, increase a detent force applied to strut 202. A magnetic attractive force (e.g., a magnetic flux) between magnetic array 206a associated with strut 202 and magnetic array 206b associated with detent magnet 208 may, for example, be applied to MR fluid 230 increasing a force applied to resist translation or movement of strut 202.

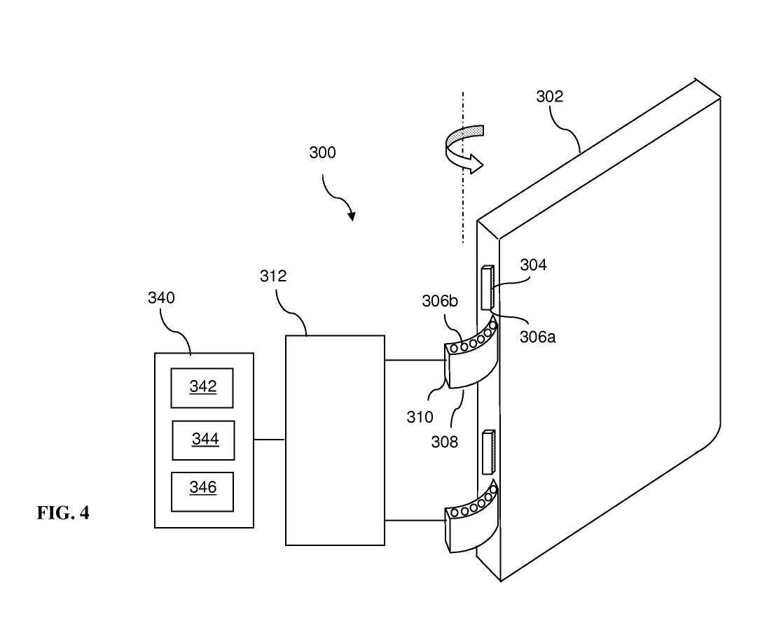

FIG. 4 is a perspective view of a detent device according to embodiments of the present invention. A detent device 300 may, for example, be associated with a door or swing panel 302. Swing panel 302 may, for example, be a vehicle door, trunk, gas tank panel door, a door, or other device including a hinge. Swing panel 302 may, for example, include a swing panel strut 304, which may include at least one magnetic array 306a. Swing panel strut 304 may, for example, be affixed (e.g., with fasteners, permanent attachment, or other affixing method or device) to swing panel 302. Detent device 300 may include at least one detent magnet 308. Detent magnets 308 may include at least one magnetic array 306b. Magnetic arrays 306b associated with detent magnet 308 may, for example, have different magnitudes (e.g., magnetic field strength). Detent magnets 308 may, for example, be a component of a bracket or wedge 310. Detent magnets 308 and/or brackets 310 may, for example, be rotated to align swing panel magnetic arrays 306a with detent magnetic arrays 306b to create a swing panel 302 detent.

In some embodiments, actuation device 312 may control position of detent magnets 308 and/or brackets 310 based on input from a control system 340. Control system 340 may, for example, control and/or provide input to actuation device 312 based on information measure by a sensor 342. Sensor 342 may, for example, be a proximity sensor (e.g., associated with a car door, trunk, swing panel, or other component), electromagnetic sensor, ultrasonic sensor, a camera, a gyroscopic sensor, inertial measurement unit(s) (IMU), or other type of sensor. Control system 340 may, for example, include one or more processor(s) or controller(s) 344, memory 346, and potentially other components. Processor or controller 344 may be, for example, a central processing unit (CPU), a chip, or any suitable computing or computational device. Processor or controller 344 may include multiple processors, and may include general-purpose processors and/or dedicated processors such as graphics processing chips. Processor 344 may execute code or instructions, for example, stored in memory 346 or another device.

In some embodiments, sensor 342 may measure a distance between swing panel 302 and other objects. If sensor 342 measured distance between swing panel 302 and an object is within a predefined threshold, control system 340 may rotate or translate one or more brackets 304 such that a swing panel magnetic array 306a aligns with a detent magnetic array 306b thereby resisting rotation or movement of swing panel 302. Contact between swing panel 302 and an object may, therefore, be mitigated or avoided. For example, swing panel 302 may be a vehicle door and sensor 342 may measure a distance between swing panel 302 (e.g., vehicle door) and other objects. If a sensor 342 measured distance between swing panel 302 (e.g., vehicle door) and another object is within a predefined distance (e.g., a distance which indicates a likelihood that vehicle door may contact object), control system 340 may rotate one or more brackets 304 such that a vehicle door magnetic array 306a aligns with a detent magnetic array 306b thereby resisting rotation or movement of vehicle door.

In some embodiments, sensor 342 may measure or determine an angle or slope of a vehicle and associated swing panel 302. Control system 340 may based on sensor 312 measured angle adjust (e.g., increase or decrease) a detent applied to swing panel 302. Actuation device 312 may, for example, rotate detent magnets to align a swing panel magnetic array 306a with a detent magnetic array 306b.

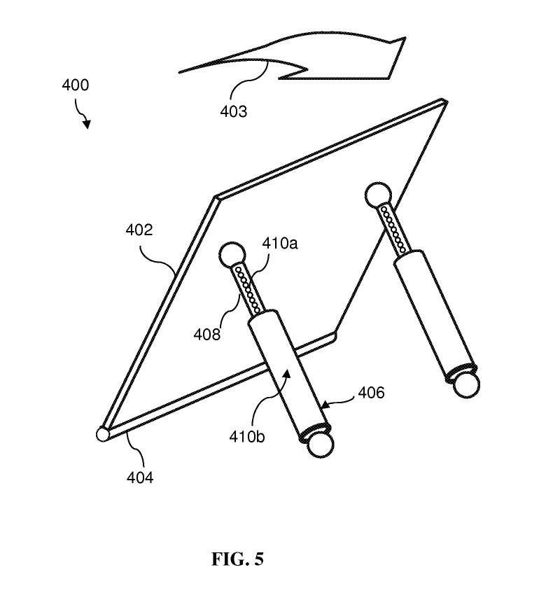

FIG. 5 is a perspective view of a detent device according to embodiments of the present invention. A detent device 400 may, for example, be associated with a door or swing panel 402. Swing panel 402 may, for example, be a vehicle door, trunk, gas tank panel door, a door, or other device. Swing panel 404 may rotate 403 about hinge 404 or one or more axes. Swing panel 404 may rotate through a range or span of translation (e.g., from closed to fully open). Swing panel 402 may be associated with or connected to a detent device 406. Detent device 406 may, for example, be a strut device, damper device, shock, or other type of device. Detent device 406 may resist movement of swing panel 402. Detent device 406 may, for example, include a strut 408, cylinder 410, and other components. A strut 408 may, for example, be affixed or attached to swing panel 402. A strut 408 may, for example, be attached to swing panel with one or more fasteners (e.g., bolts, screws, or other types of fasteners), a welded joint, or other type of joint. A strut 408 may move, slide, or translate relative to cylinder 410. A strut 408 may, for example, slide inside of cylinder 410, and the stroke of detent device 406 may define the extent of translation of strut 408 relative to cylinder 410. A strut 408 may include a magnetic array 412a (e.g., a strut magnetic array) and cylinder 410 may include a detent magnetic array 412b (e.g., a detent magnetic array or cylinder magnetic array). Strut magnetic array 41a may be complementary to detent or detent magnetic array 412b. Magnetic forces between strut magnetic array 412a and detent magnetic array 412b may, for example, resist or oppose movement of strut 408 relative to cylinder 410 provide a detent force.

In some embodiments, a strut magnetic array 412a may include a pattern or arrangement (e.g., a linear or other type of pattern) of magnetized regions 12. Magnetized regions 12 may, for example, be arranged to vary a magnetic detent force generated between strut magnetic array 412a and cylinder magnetic array 412b as strut 408 moves or slides relative to cylinder 410 (e.g., throughout stroke of detent device 406). A magnetic detent force generated between strut magnetic array 412a and cylinder magnetic array 412b may, for example, resist rotation or movement of swing panel 402. A pattern of magnetized regions in strut magnetic array 412a and/or cylinder magnetic array 412b may be arranged such that varying magnetic forces are applied or generated to resist movement of swing panel 402 depending on the angle of swing panel relative to hinge 404 and/or position of strut 408 relative to cylinder 410. For example, swing panel 402 and/or other components may apply varying gravitational moment, torque, or weight loads to detent device 406 as swing panel rotates. Strut magnetic array 412a and/or cylinder magnetic array 412b may, for example, be complementary such that a magnetic force opposing motion of strut 408 and/or swing panel 402 increases as the center of gravity of the swing panel 402 changes thereby resulting in a larger gravitational moment being applied to strut 408 and/or detent device 406. By increasing a magnetic force to resist motion of strut 408 as gravitational moment applied to strut 408 increases, the motion of swing panel may be smooth throughout the entire range (e.g., angles) of swing panel 402 motion.

Embodiments of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Embodiments of the invention may include an article such as a non-transitory computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A detent device comprising:
a strut comprising at least one strut magnetic array; and
at least one detent magnetic array, wherein the at least one detent magnetic array and the at least one strut magnetic array are operable to apply a magnetic detent force to the strut.

2. The detent device of claim 1, wherein:
the at least one strut magnetic array comprises a first spatially modulated magnetic field; and
the at least one detent magnetic array comprises a second spatially modulated magnetic field complementary to the first spatially modulated magnetic field.

3. The detent device of claim 1, comprising:
an electromechanical system to control a distance, alignment, or relative orientation between the at least one detent magnetic array and the at least one strut magnetic array.

4. The detent device of claim 3, wherein the electromechanical system comprises an actuation device to control the distance between the at least one detent magnetic array and the at least one strut magnetic array by rotating the at least one detent magnetic array about a pivot point.

5. The detent device of claim 1, wherein the at least one detent magnetic array comprises an electromagnet.

6. The detent device of claim 5, comprising a control system to activate the at least one detent magnetic array.

7. The detent device of claim 6, wherein the control system is to activatedisplace, orient, or align the at least one detent magnetic array based on a sensor measurement.

8. The detent device of claim 1, wherein the strut comprises a component of a swing panel.

9. The detent device of claim 8, wherein the swing panel comprises a vehicle door.

10. The detent device of claim 1, comprising a magnetorheological fluid to increase a magnetic detent force applied to the strut.

11. The detent device of claim 1, wherein a magnitude of the detent force is based on a distance between the at least one strut magnetic array and the at least one detent magnetic array.

12. The detent device of claim 1, comprising:
a swing panel affixed to the strut; and
a cylinder comprising the at least one detent magnetic array, the strut operable to slide relative to the cylinder and the detent magnetic array and the strut magnetic array operable to generate a varying magnetic detent force as the strut slides relative to the cylinder.

13. A detent device comprising:
a swing panel;
a strut comprising one or more strut magnetic arrays, wherein the strut is affixed to the swing panel; and
one or more detent magnetic arrays, wherein the one or more strut magnetic arrays and the one or more detent magnetic arrays are operable to apply a magnetic detent load to the swing panel.

14. The detent device of claim 13, wherein:
the one or more strut magnetic arrays comprise a first array of one or more positively magnetized regions and negatively magnetized regions; and
the one or more detent magnetic arrays comprise a second array of one or more positively magnetized regions and negatively magnetized regions complementary to the first spatially modulated magnetic field.

15. The detent device of claim 13, comprising an actuation device to control a distance, alignment, or relative orientation between the one or more detent magnetic arrays and the one or more strut magnetic arrays to selectively apply the magnetic detent load to the swing panel.

16. The detent device of claim 15, comprising a sensor to measure a distance between the swing panel and an object, wherein the actuation device is operable to selectively apply the magnetic detent load to the swing panel based on the measured distance.

17. The detent device of claim 13, wherein the swing panel comprises a vehicle door.

18. The detent device of claim 1, comprising a magnetorheological fluid to increase a magnetic detent load applied to the swing panel.

19. A method for operating a detent device comprising:
moving a strut comprising at least one strut magnetic array; and
rotating, using an actuator, at least one detent magnet comprising at least one detent magnetic arrays to control the distance between the at least one detent magnetic array and the at least one strut magnetic array.

20. The method of claim 19, wherein rotating the at least one detent magnet comprises:
measuring, using a sensor, a spatial orientation of a component associated with the strut; and
rotating the at least one detent magnet to apply a magnetic detent force based on the measured spatial orientation.
